(19) United States
(12) Patent Application Publication
(10) Pub. No.: US 2007/0198947 A1
(43) Pub. Date: Aug. 23, 2007

(54) SLIDING TABS

(75) Inventors: Patrick Cox, Raleigh, NC (US); Patrick G. McGowan, Chapel Hill, NC (US); Jeremy G. Perry, Cary, NC (US)

Correspondence Address: MOORE & VAN ALLEN, PLLC For IBM, P.O. Box 13706, Research Triangle Park, NC, 27709, US

(73) Assignee: International Business Machines Corporation, Armonk, NY (US)

(21) Appl. No.: 11/307,787

(22) Filed: Feb. 22, 2006

(51) Int. Cl. G06F 3/048

(52) U.S. Cl. 715/786; 715/774; 715/777

(57) ABSTRACT

A method to control presentation of multiple tabs and associated content on a display may include distinguishing a selected tab from the multiple tabs and displaying the content associated with the selected tab on the display. The method may also include performing one of a group of functions that may include auto-scrolling the multiple tabs across the display in response to selecting another tab, wherein at least one tab is only partially visible; scrolling at least the unselected tabs in an animated ticker fashion across the display; or facilitating manual scrolling of at least the unselected tabs across the display.

### BACKGROUND OF THE INVENTION

The present invention relates to graphical user interfaces tabbed dialogs or the like, and more particularly to a method and system to navigate between multiple tabs when there are more tabs than can be conveniently or efficiently presented simultaneously on a display because of limited display size.

Tabs are often used in association with graphical user interfaces (GUIs) or the like where there may be multiple dialogs, input forms for selecting or specifying different options or the like, or other types of pages containing different content. Each tabbed dialog, input form or other content page may have an associated tab that may be selected for presenting the dialog or associated content. Tabbed dialogs are frequently used in dialogs that have many user interface controls. These controls are often conceptually grouped within each tab. In some cases, such as preference dialogs, there may be a multiplicity of tabs to logically and efficiently segment related sets of user interface controls. In a desktop or laptop application environment, the display of all tabs simultaneously may rarely be an issue because the tabs can typically be scaled and still be usable. However, on the mobile handheld device, where screen real estate is at a premium, only three or four tabs may be practically and usably displayed at one time. A multiple row arrangement may be possible, but this may sacrifice much of the display area for user interface (UI) elements and possibly entail a need to scroll the tabbed page. Scrolling introduces an additional set of usability concerns, such as providing practical and convenient means for efficiently scrolling on such mobile devices. Another approach to facilitate multiple tabs that exceed the display space available on a single row has been to implement stationary arrow controls on each side of the visible tabs. This technique allows the user to scroll through the set of tabs one at a time. However, this implementation is usually cumbersome and inefficient, requiring sequential movement through the tab set one tab at a time.

### BRIEF SUMMARY OF THE INVENTION

In accordance with an embodiment of the present invention, a method to control presentation of multiple tabs and associated content on a display may include distinguishing a selected tab from the multiple tabs and displaying the content associated with the selected tab on the display. The method may also include performing one of a group of functions or operations that may include auto-scrolling the multiple tabs across the display in response to selecting another tab, wherein at least one tab is only partially visible on the display; scrolling at least the unselected tabs in an animated ticker fashion across the display; or facilitating manual scrolling of at least the unselected tabs across the display.

In accordance with another embodiment of the present invention, a system for at least one of computing and communicating may include a display. The system may also include a module to control presentation of multiple tabs and associated content of each tab on the display, wherein only some tabs of the multiple tabs are substantially completely visible on the display simultaneously and the multiple tabs being slidable to present any partially visible and non-visible tabs.

In accordance with another embodiment of the present invention, a computer program product to control presentation of multiple tabs and associated content on a display may include a computer usable medium having computer usable program code embodied therein. The computer usable medium may include computer usable program code configured to distinguish a selected tab from the multiple tabs and to display the content associated with the selected tab on the display. The computer usable medium may also include computer usable program code configured to perform one of a group of functions or operations that may include auto-scrolling the multiple tabs across the display in response to selecting another tab, wherein at least one tab is only partially visible; scrolling at least the unselected tabs in an animated ticker fashion across the display; or facilitating manual scrolling of at least the unselected tabs across the display.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method to control presentation of multiple tabs and associated content on a display in accordance with an embodiment of the present invention.

FIGS. 2A and 2B illustrate an exemplary tabbed dialog or GUI with multiple tabs demonstrating the method of FIG. 1.

FIG. 3 is a flow chart of an example of a method to control presentation of multiple tabs and associated content on a display in accordance with another embodiment of the present invention.

FIGS. 4A and 4B illustrate an exemplary tabbed dialog or GUI with multiple tabs demonstrating a method to control presentation of multiple tabs and associated content on a display in accordance with an embodiment of the present invention.

FIGS. 5A and 5B illustrate an exemplary tabbed dialog or GUI with multiple tabs demonstrating a method to control presentation of multiple tabs and associated content on a display in accordance with another embodiment of the present invention.

FIGS. 6A, 6B and 6C illustrate an exemplary tabbed dialog or GUI with multiple tabs demonstrating a method to control presentation of multiple tabs and associated content on a display in accordance with another embodiment of the present invention.

FIG. 7 is a block diagram of an example of a system to control presentation of multiple tabs and associated content on a display in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

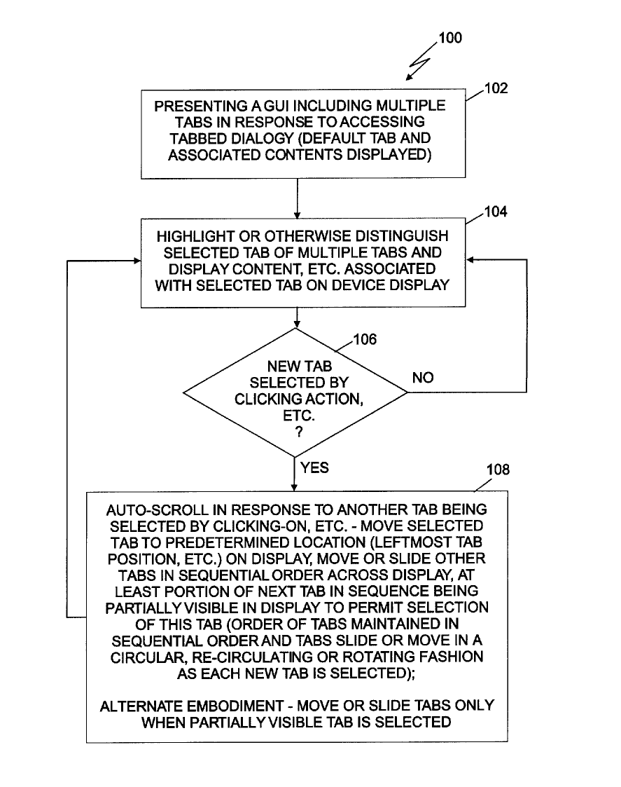

FIG. 1 is a flow chart of an example of a method 100 to control presentation of multiple tabs and associated content on a display in accordance with an embodiment of the present invention. In block 102, a tabbed dialog or GUI including multiple tabs may be presented on a display of a device or system in response to a user accessing the tabbed dialog. A default tab may be automatically selected and its associated contents displayed. The device or system may be a personal digital assistant, a mobile communications device or the like. In block 104, a selected tab of the multiple tabs may be highlighted or otherwise distinguished from the other tabs. The content associated with the selected tab may also be presented on the display.

In block 106, a determination may be made whether a new tab has been selected. The new tab may be selected by a clicking action using a computer pointing device, such as a mouse, touchpad, multi-position button or similar pointing device. If a new tab has not been selected, the method 100 may return to block 104. If a new tab has been selected, the method 100 may advance to block 108.

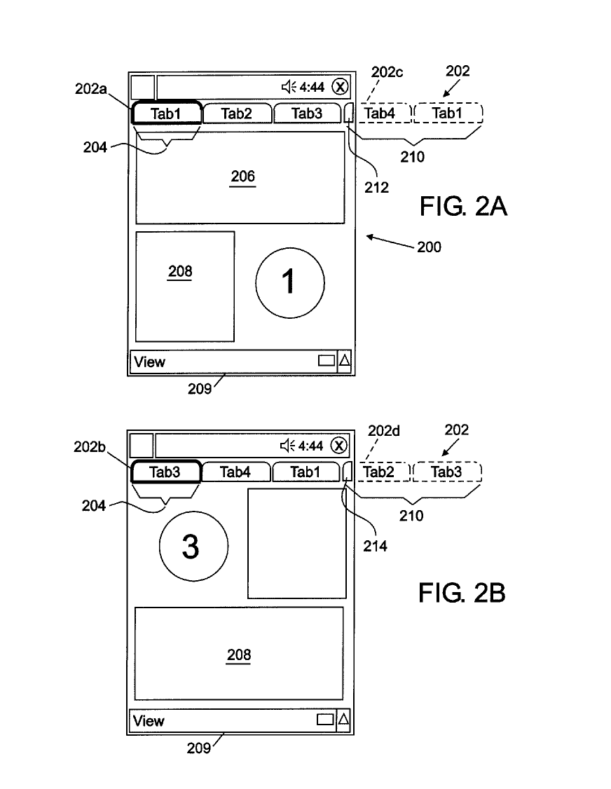

In block 108, the tabs may be auto-scrolled in response to another tab being selected. By auto-scrolling, the selected tab may be automatically moved to a predetermined location or position on the display. For example, the selected tab may be moved to a leftmost tab position 204 as illustrated in FIGS. 2A and 2B.

Referring also to FIGS. 2A and 2B, FIGS. 2A and 2B illustrate an exemplary tabbed dialog 200 or GUI with multiple tabs 202 demonstrating the method 100 of FIG. 1. In FIG. 2A, Tab 1 202a has been selected and has been slid or moved to the leftmost tab position 204. The content 206 associated with Tab 1 202a is also being displayed in the tabbed dialog 200 or GUI. The selected tab 202a may also be distinguished from the unselected tabs 202 by highlighting or some other distinguishing characteristic. Selected Tab 1 202a is illustrated as being distinguished or highlighted by a heavier or bolder outline in FIG. 2A. The selected tab 202a may be distinguished from the other tabs 202 by any means that may be apparent to a user, such as causing the tab to blink, outlining the tab in a dashed or broken line or other ways.

In FIG. 2B, Tab 3 202b has been selected and has been moved or slid to the predetermined location or leftmost tab position 204. The contents 208 associated with selected Tab 3 202b may also be displayed in response to selection of Tab 3. Tab 3 202b has also been distinguished from the other tabs 202 by being highlighted as illustrated by the heavier or bolder outline in FIG. 2B.

As illustrated in the exemplary embodiment of FIG. 2B, the tabs 202 may slide or move across the display in a predefined sequential order in response to a new tab 202 being selected. The sequential order of the tabs 202 may be maintained and the tabs may slide or move in a circular, re-circulating or rotating fashion as each new tab is selected. This circular, re-circulating or rotational movement of the tabs 202 is illustrated in FIGS. 2A and 2B by showing the sequential order of the tabs 202 being continued conceptually in phantom or by broken lines beyond the tabbed dialog 200 or display 209. Accordingly, a group 210 of tabs 202 may be partially or substantially completely obscured.

In accordance with an embodiment of the present invention, the next tab (Tab 4 202c in FIG. 2A and Tab 2 202d in FIG. 2B) in the sequence may only be partially visible in the display 209 as illustrated by the portion 212 of Tab 4 in FIG. 2A and the portion 214 of Tab 2 202d in FIG. 2B because the display 209 may have limited size to practically and efficiently display all of the tabs 202. The partially visible tab (Tab 4 202c in FIG. 2A or Tab 2 202d in FIG. 2B) may be selected by clicking-on or otherwise selecting the visible portion 212 or 214 of the respective tab 202c or 202d.

In accordance with another embodiment of the present invention, the tabs 202 may only slide or move to the predetermined location or leftmost tab position 204 in response to only the portion 210 or 212 of the partially visible tab being selected. Accordingly, if a tab 202 currently substantially completely visible in the display is selected, the tabs 202 may not slide or move and the selected tab may merely be distinguished from the other tabs by highlighting or other means. If the visible portion 210 or 212 of a partially visible tab 202 is clicked-on or otherwise selected, the selected tab 202 may slide or move to the predetermined or leftmost tab position 204 and the other tabs may also slide in sequential order.

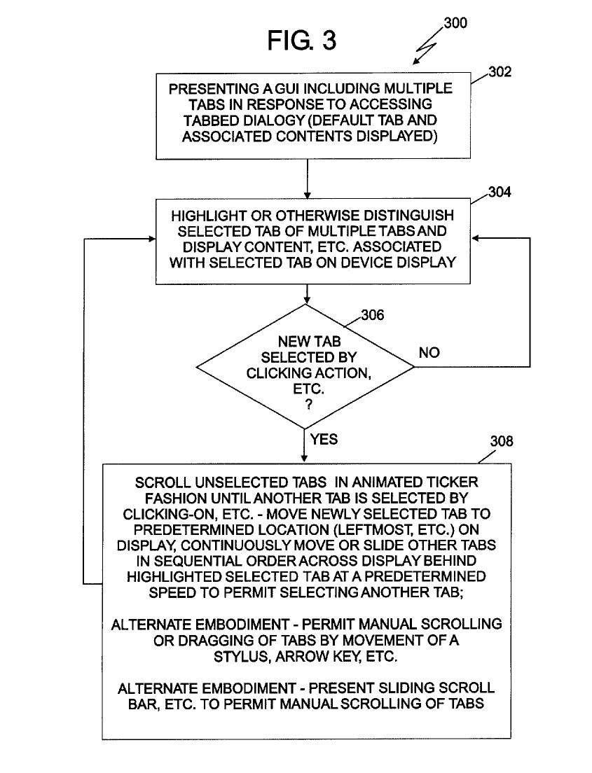

FIG. 3 is a flow chart of an example of a method 300 to control presentation of multiple tabs and associated content on a display in accordance with another embodiment of the present invention. In block 302, a tabbed dialog, GUI or the like including multiple tabs may be presented on a display of a device in response to a user accessing the tabbed dialog. One tab of the multiple tabs may be automatically selected by default and the contents of the associated page may be displayed when the tabbed dialog is accessed. The device may be a personal digital assistance (PDA), mobile communications device or the like. In block 304, a selected tab of the multiple tabs may be highlighted or otherwise distinguished from the other tabs. The content associated with the selected tab may also be presented on the display.

In block 306, a determination may be made whether a new tab has been selected. The new tab may be selected by a clicking action using a computer pointing device, such as mouse, touchpad, multi-position button or similar pointing device, similar to that previously discussed. If a new tab has not been selected, the method 300 may return to block 304. If a new tab has been selected, the method 300 may advance to block 308.

In block 308, the unselected tabs may be scrolled across the display in an animated ticker fashion until another tab is selected by clicking-on a new tab using a pointing device or otherwise selecting a new tab. The newly selected tab may be moved to a predetermined location, such as a leftmost tab position or the like on the display similar to that previously described. The selected tab may also be distinguished from the unselected tabs by highlighting or some other distinguishing characteristic. The unselected tabs may continuously move or slide across the display in an animated ticker fashion. The unselected tabs may pass behind the selected tab at a predetermined speed to permit selecting another tab. An option may be provided to adjust the predetermined speed.

In another embodiment of the present invention, all tabs could be scrolled, although this may be confusing to a user as to which tab may be associated with the displayed page. The scrolling tab associated with the displayed page may be distinguished from the unselected tabs being scrolled to possibly minimize any such confusion.

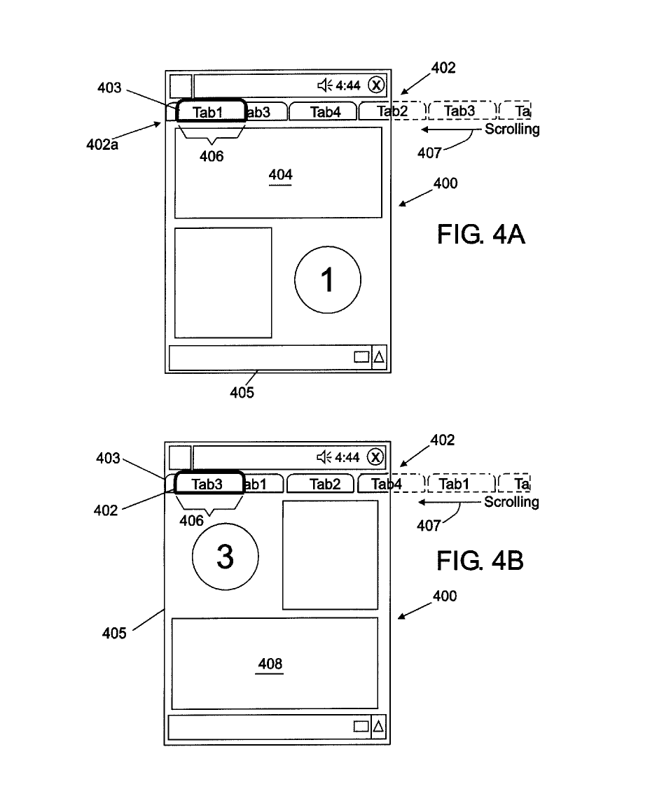

Referring also to FIGS. 4A and 4B, FIGS. 4A and 4B illustrate an exemplary tabbed dialog 400 or GUI with multiple tabs 402 demonstrating a method to control presentation of multiple tabs and associated content 404 on a display 405 in accordance with an embodiment of the present invention by automatically scrolling at least the unselected tabs in an animated ticker 403 similar to the method 300 in FIG. 3. In FIG. 4A, Tab 1 402a has been selected. Tab 1 402a is illustrated as having been slid or moved to a predetermined location 406 (leftmost tab position) and distinguished from the other tabs 402 by highlighting. The tabs 402 may be scrolled across the display 405 or tabbed dialog 400 as represented by the arrow 407 in the animated ticker fashion at a predetermined speed to permit selection of another tab. The tabs 402 may be scrolled in a predefined sequence. While the arrow 407 illustrates the tabs 402 being automatically scrolled from right to left, the tabs 402 could be scrolled in any direction or configured to scroll in a vertical direction.

In FIG. 4B, Tab 3 402b has been selected. Tab 3 402b has been moved or slid to the predetermined location 406 and highlighted. The content 408 associated with Tab 3 402b may also be displayed in response to the selection of Tab 3 402b. At least the unselected tabs 402 may continue scrolling across the display 400 at the predetermined speed until another tab is selected as previously described.

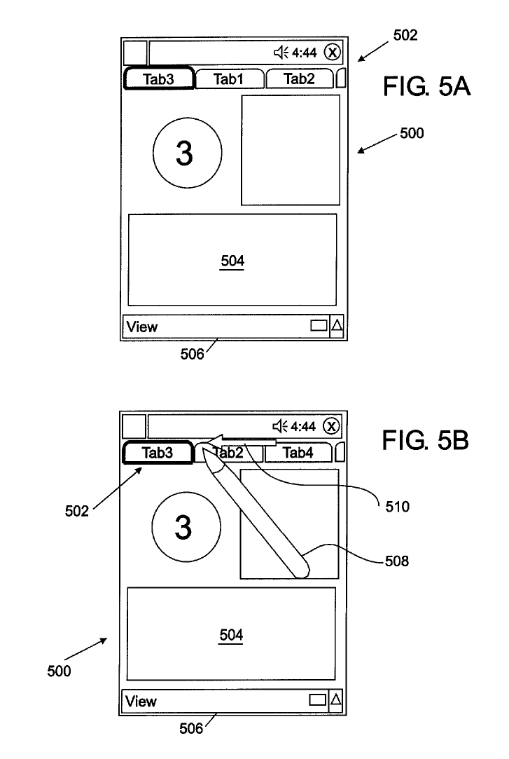

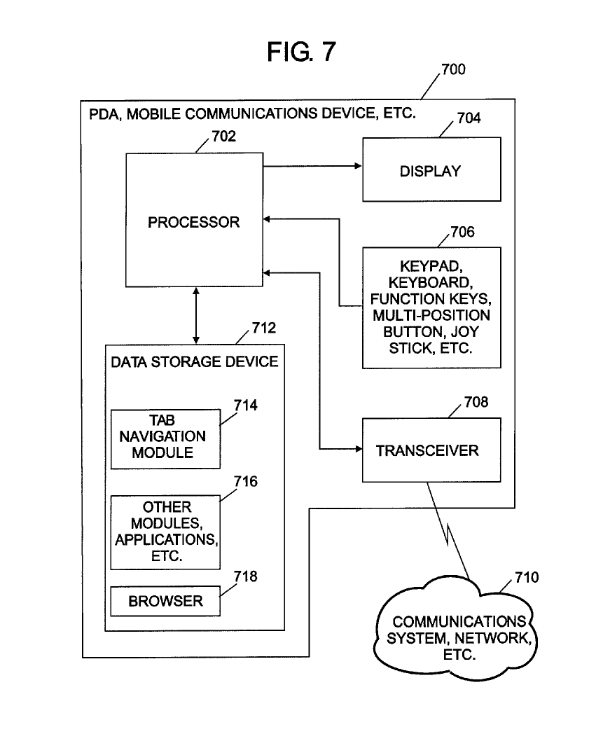

Referring back to block 308 in FIG. 3, in another embodiment of the present invention, an arrangement to facilitate or permit manually sliding the unselected tabs may be provided. Referring also to FIGS. 5A-5B, FIGS. 5A-5B illustrate an exemplary tabbed dialog 500 or GUI demonstrating a method to control presentation of multiple tabs 502 and associated content 504 on a display 506 by manually sliding at least the unselected tabs 502 in accordance with another embodiment of the present invention. A stylus 508 or other means may be provided to permit scrolling the tabs 502 as illustrated by the arrow 510 and selecting a new tab. Arrow keys, a multi-position button or similar arrangement may be provided on a device or system, such as the device 700 in FIG. 7, to scroll the tabs 502 as an alternative to the stylus 508 or either means may be used.

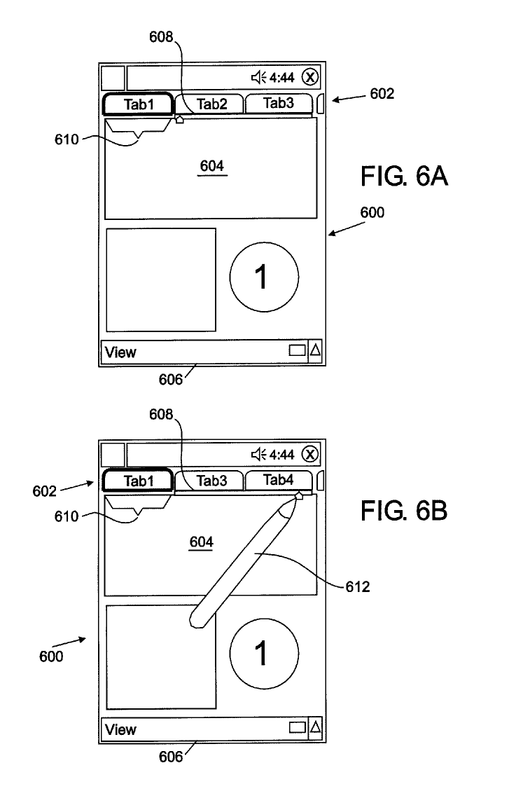

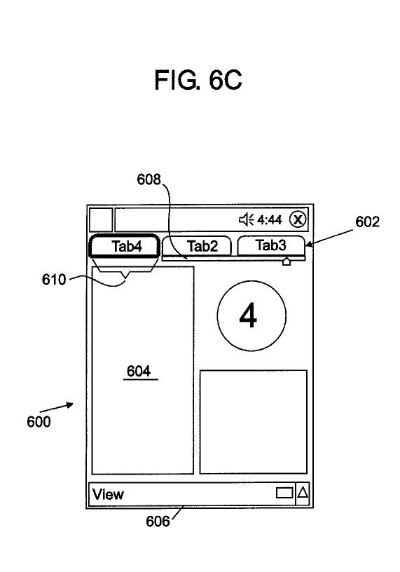

Referring back to block 308 in FIG. 3, in another embodiment of the present invention, a sliding scroll bar or the like may be provided to facilitate or permit manual scrolling of the tabs. Referring also to FIGS. 6A-6C, FIGS. 6A-6C illustrate an exemplary tabbed dialog 600 or GUI with multiple tabs 602 demonstrating a method to control presentation of the multiple tabs 602 and associated content 604 on a display 606 by presenting a scroll bar or similar means in accordance with another embodiment of the present invention. A scroll bar 608 may be provided in the tabbed dialog 600 to scroll the tabs 602 and to select a new tab that may be moved to a predetermined location 610 (or leftmost position) and distinguished from unselected tabs as illustrated in FIGS. 6A-6C. A stylus 612 or other means may be used to operate the scroll bar 608.

With respect to the embodiments described with reference to FIGS. 3, 4A-4B, 5A-5B, and 6A-6C, a new tab does not have to be selected to demonstrate the action of the tabs. Similar to that discussed with respect to block 302 of method 300 (FIG. 3), if the tabbed dialog is presented to the user, a tab may automatically be selected by default and the contents of its associated page may be displayed. Due to this, the ticker arrangement of FIGS. 4A and 4B of other unselected tabs may already be in motion in the background. The user must then select one of the ticker tabs (a new tab) to see the contents on that tab's page. In short, no new tab needs to be selected in order for the ticker to scroll. Likewise for the dragging of tabs in the embodiment of FIGS. 5A-5B and sliding scroll bar 608 in the embodiment of FIGS. 6A-6C, which can actually be considered a control mechanism for a “manual ticker,” these actions may be performed without selecting a new tab.

FIG. 7 is a block diagram of an example of a system 700 to control presentation of multiple tabs and associated content on a display in accordance with an embodiment of the present invention. The methods 100 and 300 and the embodiments described with reference FIGS. 2A-2B, 4A-4B, 5A-5B and 6A-6B may be embodied in the system 700. The system 700 may be a personal digital assistance (PDA), handheld computing system, communications device or the like. The system 700 may include a processor 702 to control overall operation of the system 700.

The system 700 may include a display 704 to present tabbed dialogs similar to those illustrated in FIGS. 2A-2B, 4A-4B, 5A-5B and 6A-6B, GUIs or other information. The system 700 may also include input means 706, such as a keypad, keyboard, functions keys, multi-position button, joystick or the like to enter information into the system 700, control the system 700 and control presentation of multiple tabs and associated content as described herein. The system 700 may also include a transceiver 708 for wireless mobile communications, such as cellular telephony, Wireless Local Area Network (WLAN), Wireless Fidelity (WiFi) or other wireless communications. The transceiver 708 may permit the system 700 to access a communications system or network 710 for communications with other systems or devices.

The system 700 may further include a data storage device 712. The data storage device 712 may contain a tab navigation module 714 or module to control presentation of multiple tabs and associated content on the display 704. The method 100 or the method 300 or both and the embodiments described with reference to FIGS. 2A-2B, 4A-4B, 5A-5B and/or 6A-6B described herein may be embodied in the module 714.

The data storage device 712 may also store other modules 716, applications or the like for other functions or operations performable by the system 700. The system 700 or device may also include a browser 718 to permit the system 700 to access the Internet, a private network or other networks via the communications system or network 710.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method to control presentation of multiple tabs and associated content on a display, the method comprising:
distinguishing a selected tab from the multiple tabs and displaying the content associated with the selected tab on the display;
performing one of a group comprising:
auto-scrolling the multiple tabs across the display in response to selecting another tab, wherein at least one tab is only partially visible on the display;
scrolling at least the unselected tabs in an animated ticker fashion across the display; and
facilitating manual scrolling of at least the unselected tabs across the display.

2. The method of claim 1, wherein facilitating manual scrolling comprises presenting one of a sliding means and a scroll bar.

3. The method of claim 1, wherein facilitating manual scrolling comprises manually scrolling at least the unselected tabs in response to operation of one of a function key, a multi-position button, a touchpad, and a joystick, on a device.

4. The method of claim 1, further comprising moving a newly selected tab of the multiple tabs to a predetermined location on the display in response to the newly selected tab being selected.

5. The method of claim 1, further comprising moving a newly selected tab of the multiple tabs to a leftmost tab position on the display in response to the newly selected tab being selected.

6. The method of claim 1, further comprising scrolling the multiple tabs in a re-circulating fashion in a predefined sequential order.

7. The method of claim 1, further comprising maintaining the multiple tabs in a predefined sequential order during auto-scrolling and scrolling.

8. The method of claim 1, further comprising auto-scrolling the multiple tabs only in response to the partially visible tab being selected.

9. The method of claim 1, wherein scrolling at least the unselected tabs in an animated ticker fashion comprises continuously sliding the multiple tabs in a predefined sequential order across the display behind the selected tab.

10. The method of claim 9, further comprising sliding the multiple tabs at a predetermined speed to permit selecting a new tab.

11. A system for at least one of computing and communicating, comprising:
a display; and
a module to control presentation of multiple tabs and associated content of each tab on the display, wherein only some tabs of the multiple tabs are substantially completely visible on the display simultaneously and the multiple tabs being slidable to present any partially visible and non-visible tabs.

12. The system of claim 11, wherein the module to control presentation of multiple tabs and associated content is adapted to perform one of a group comprising:
auto-scrolling the multiple tabs across the display in response to selecting another tab, wherein at least one tab is only partially visible;
scrolling at least the unselected tabs in an animated ticker fashion across the display; and
facilitating manual scrolling of at least the unselected tabs across the display.

13. The system of claim 11, further comprising one of a sliding means and a scroll bar presentable on the display to facilitate manual scrolling of the multiple tabs.

14. The system of claim 11, further comprising a predetermined location on the display to where a newly selected tab is movable in response to selection.

15. The system of claim 11, further comprising:
a processor, wherein the module to control presentation of the multiple tab is operable on the processor; and
a transceiver coupleable to the processor for communications.

16. A computer program product to control presentation of multiple tabs and associated content on a display, the computer program product comprising:
a computer usable medium having computer usable program code embodied therein, the computer usable medium comprising:
computer usable program code configured to distinguish a selected tab from the multiple tabs and to display the content associated with the selected tab on the display; and
computer usable program code configured to perform one of a group comprising:
auto-scrolling the multiple tabs across the display in response to selecting another tab, wherein at least one tab is only partially visible;
scrolling at least the unselected tabs in an animated ticker fashion across the display; and
facilitating manual scrolling of at least the unselected tabs across the display.

17. The computer program product of claim 16, further comprising computer usable program code configured to scroll at least the unselected tabs in response to operation of one of a virtual sliding means, a virtual scroll bar rendered on the display, a function key, a multi-position button, a touchpad and a joystick on a device.

18. The computer program product of claim 16, further comprising computer usable program code configured to move a new tab of the multiple tabs to a predetermined location on the display in response to the new tab being selected.

19. The computer program product of claim 16, further comprising computer usable program code configured to scroll the multiple tabs in a re-circulating fashion in a predefined sequential order.

20. The computer program product of claim 16, further comprising: computer usable program code configured to auto-scroll the multiple tabs only in response to the partially visible tab being selected.

21. The computer program product of claim 16, further comprising computer usable program code configured to continuously slide the multiple tabs in the animated ticker fashion at a predetermined speed to permit selecting a new tab.
